(19) United States
(12) Patent Application Publication
(10) Pub. No.: US 2014/0372361 A1
(43) Pub. Date: Dec. 18, 2014

(54) APPARATUS AND METHOD FOR PROVIDING SUBSCRIBER BIG DATA INFORMATION IN CLOUD COMPUTING ENVIRONMENT

(71) Applicant: Electronics and Telecommunications Research Institute, Daejeon-si (KR)

(72) Inventors: Kang-Chan LEE, Daejeon-si (KR); Min-Kyo IN, Daejeon-si (KR); Seung-Yun LEE, Daejeon-si (KR)

(21) Appl. No.: 14/303,781

(22) Filed: Jun. 13, 2014

(30) Foreign Application Priority Data
Jun. 14, 2013 (KR) 10-2013-0068557
Jun. 12, 2014 (KR) 10-2014-0071657

(51) Int. Cl. G06N 5/04

(52) U.S. Cl. CPC G06N 5/04
USPC 706/50

(57) ABSTRACT

An apparatus and method for providing big data information based on a subscriber's behavior. The apparatus includes a subscriber behavior information collector configured to collect real-time-subscriber-behavior-information obtained based on packets that a user device transmits and receives in real-time when using an Internet service; an additional subscriber information collector configured to collect subscriber-related information including personal information; an environmental information collector configured to collect environmental information that is information about factors extrinsic to subscriber's behavior; a big data extractor configured to extract real-time subscriber big data using the collected real-time-subscriber-behavior-information, subscriber-related information, and environmental information; and a real-time analyzer configured to generate subscriber's real-time characteristic information associated with the subscriber by analyzing cumulative big data that is generated by accumulating the real-time subscriber big data extracted by the big data extractor.

### CROSS-REFERENCE TO RELATED APPLICATION(S)

This application claims priority from Korean Patent Application Nos. 10-2013-0068557, filed on Jun. 14, 2013, and 10-2014-0071657, filed on Jun. 12, 2014, in the Korean Intellectual Property Office, the disclosures of which are incorporated herein by references in its entirety.

### BACKGROUND

1. Field

The following description relates to a big data system, and more particularly, to an apparatus and method for providing subscriber big data information in a cloud computing environment.

2. Description of the Related Art

Cloud computing enables not only users but also providers to share various Internet technology (IT) resources, such as networks, servers, and storages. Cloud computing involves elements for supporting a wide range of services. For example, the cloud computing involves elements for supporting software as a server (SaaS), infra as a service (IaaS), platform as a service (PaaS), and device as a service (DaaS).

The users using the cloud computing may use, via an Internet network (online), necessary computing resources from the IT resources shared in a server side of a cloud service provider at anytime and anywhere. Thus, for the cloud computing, a user device needs to be able to seamlessly access the server of the cloud service provider via the Internet. In addition, all requests of the users using the cloud service and responses from the service providers may be transmitted and received through data exchange, i.e., packet exchange, between the user devices and the service providers via the Internet.

Recently, research and development on big data have been actively conducted. Big data refers to massive amounts of data collected during a predetermined time, which are generally data sets that are difficult to be deal with using common software tools or computing systems. The big data is not specified in size, but usually more than terabytes, and may be exabytes or zettabytes. A type of big data may vary depending on type, attributes, relevance, and classification criterion of data.

Big data may be utilized as an Internet paradigm to find a new value by collecting and analyzing data in the Internet environment. That is, research on big data may be related to technologies for collecting, managing, storing, searching, sharing, analyzing, and using the massive amounts of data. For example, Korean patent application publication No. 10-2013-0077761 discloses “a data processing method, a data processing apparatus, a data collecting method and a data providing method,” in which big data related to a user's objects of interest. In addition, Korean patent application publication No. 10-2009-0019462 discloses “an apparatus and method for analyzing mobile data using data mining mechanism,” in which correlation between a variety of mobile data, for example, messages, voice calls, voice data, personal data, contacts, multimedia content, Internet data, and the like is analyzed to identify a task or an activity of each mobile device. Further, Korean patent application publication No. 10-2014-0005474 discloses “an apparatus and method for providing an application for processing big data,” in which big data including structured and non-structured data is collected and analyzed to provide a customized online service to each of a plurality of tenants.

The aforementioned applications only disclose technologies to provide a customized service by collecting, managing, storing, searching, sharing, and analyzing big data manually or by online, or by utilizing analyzed big data.

### RELATED ART DOCUMENTS

### [Patent Applications]

1. Korean patent application publication No. 10-2013-0077761, “Data processing method, data processing apparatus, data collecting method, and information providing method”
2. Korean patent application publication No. 10-2009-0019462, “Apparatus and method for analyzing mobile data using data mining mechanism”
3. Korean patent application publication No. 10-2014-0005474, “Apparatus and method for providing application for processing big data”

### SUMMARY

The following description relates to an apparatus and method for providing subscriber big data information for offering a customized service to a subscriber in an environment in which cloud services are commonly used and various Internet services are provided.

The following description also relates to an apparatus and method for providing subscriber big data, which are capable of collecting not only a variety of information of a user that uses an online network but also a user-related information about a user accessing an Internet service, and of providing an Internet service more suitable to the user in real-time.

In one general aspect, there is provided an apparatus for providing big data information based on a subscriber's real-time behavior, including: a subscriber behavior information collector configured to collect real-time-subscriber-behavior-information obtained based on packets that a user device transmits and receives in real-time when using an Internet service; an additional subscriber information collector configured to collect subscriber-related information including personal information; an environmental information collector configured to collect environmental information that is information about factors extrinsic to subscriber's behavior; a big data extractor configured to extract real-time subscriber big data using the collected real-time-subscriber-behavior-information, subscriber-related information, and environmental information; and a real-time analyzer configured to generate subscriber's real-time characteristic information associated with the subscriber by analyzing cumulative big data that is generated by accumulating the real-time subscriber big data extracted by the big data extractor.

The apparatus may further include a distributed storage configured to store the cumulative big data in a distributed environment, wherein the real-time analyzer is configured to analyze the cumulative big data stored in the distributed storage. In this case, the distributed storage may be configured to include a subscriber log manager to manage information on a past behavior of the subscriber. The distributed storage may be configured to further store the subscriber's real-time characteristic information generated by the real-time analyzer, and the real-time analyzer may be configured to generate subscriber's real-time characteristic information by additionally using subscriber's real-time characteristic information previously stored in the distributed storage.

The real-time-subscriber-behavior-information may include at least one of following information: information about a web page accessed by the subscriber, service usage information about a service used by the subscriber in an accessed web page, and application usage information about an application used by the subscriber.

Either or both of a network provider and a manager of the apparatus may execute analysis of the packets transmitted and received to obtain the real-time-subscriber-behavior-information.

The subscriber behavior information collector may be configured to include: a packet analyzer configured to analyze packets in real-time that are transmitted and received by the user device; a subscriber data extractor configured to extract subscriber data using analysis result of the packet analyzer; and a subscriber behavior extractor configured to extract the real-time-subscriber-behavior-information from the subscriber data extracted from the subscriber data extractor. The user device may be configured to include a behavior collection enabler to enable the subscriber to decide to permit or not to permit real-time analysis of the packets that the subscriber device transmits and receives, and the subscriber behavior information collector may be configured to further comprise a subscriber behavior authority manager to manage information about whether or not it is permitted to collect the real-time behavior information from the user device, based on ON/OFF state of the behavior collection enabler.

In response to a request from a big data system user for big data information associated with a specific subscriber, the real-time analyzer may generate real-time characteristic information of the specific subscriber and forward the information to the big data system user.

The big data system user may include a subscriber preference manager to manage preference of the subscriber using the forwarded real-time characteristic information of the subscriber.

In another general aspect, there is provided a method of providing big data information based on a real-time behavior of a subscriber using an Internet service, the method including: collecting real-time-subscriber-behavior-information based on packets that a user device transmits and receives in real-time when using an Internet service; collecting subscriber-related information including personal information; collecting environmental information that is information about factors extrinsic to the subscriber's behavior; extracting real-time subscriber big data using the collected real-time-subscriber-behavior-information, subscriber-related information, and environmental information; and generating subscriber's real-time characteristic information associated with the subscriber by analyzing cumulative big data that is generated by accumulating the extracted real-time subscriber big data.

Other features and aspects will be apparent from the following detailed description, the drawings, and the claims.

### BRIEF DESCRIPTION OF THE DRAWINGS

FIG. 1 is a diagram illustrating a service system based on a cloud computing environment in which an apparatus for providing a user (subscriber) with big data information in accordance with an exemplary embodiment.

FIG. 2 is a diagram schematically illustrating the user device 100 in the service system of FIG. 1.

FIG. 3 is a diagram schematically illustrating the network provider of the service system of FIG. 1.

FIG. 4 is a flowchart illustrating an example of procedures to obtain subscriber's permission to collect the real-time-subscriber-behavior-information.

FIG. 5A is a diagram schematically illustrating an example of the big-data information provision apparatus in the service system of FIG. 1.

FIG. 5B is a diagram schematically illustrating another example of the big-data information provision apparatus in the service system of FIG. 1.

FIG. 6 is diagram schematically illustrating a big data user to use the subscriber's real-time characteristic information generated by the big-data information provision apparatus of FIG. 1.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

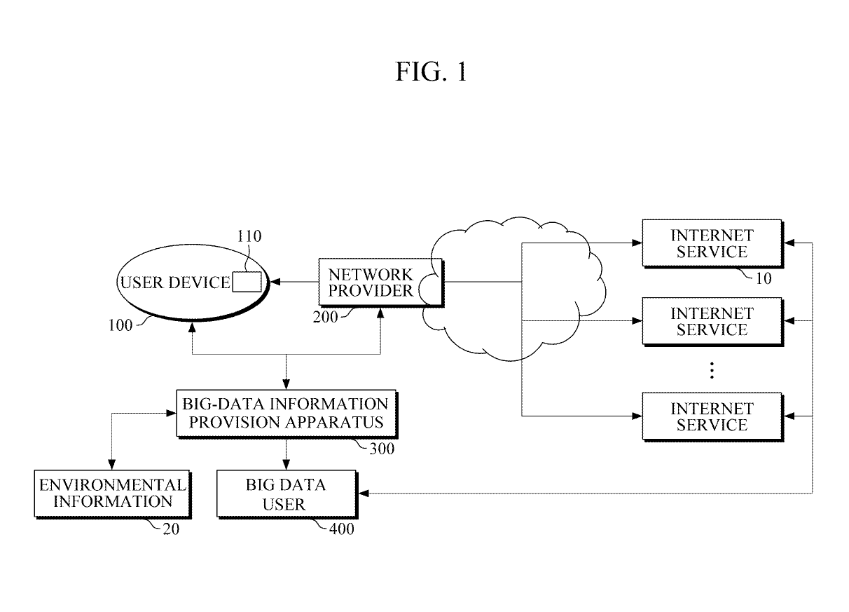

FIG. 1 is a diagram illustrating a service system based on a cloud computing environment in which an apparatus for providing a user (subscriber) with big data information in accordance with an exemplary embodiment. Referring to FIG. 1, the service system may include a user device 100, a network provider or an Internet service provider (ISP) 200, an apparatus 300 for providing subscriber big data information (hereinafter, will be referred to as the “big-data information provision apparatus”), and a big data user 400. A number of Internet services 10 may be provided via the network provider 200, and the big-data information provision apparatus 300 may collect environmental information 20 that is information about factors extrinsic to a subscriber's behavior.

More specifically, the user device 100 in the service system of FIG. 1 uses at least one Internet service 10 through a network of the network provider 200. Here, the user device 100 may use the Internet service 10 that offers cloud computing and/or use another Internet service 10 through cloud computing. In this situation, the big-data information provision apparatus 300 may collect real-time-subscriber-behavior-information directly and/or through the network provider 200. To this end, the network provider 200 and/or the big-data information provision apparatus 300 may analyze packets in real-time that are transmitted and received by the user device 100 which is using the Internet service. In addition, the big-data information provision apparatus 300 may collect user-relevant information including personal information through the user device 100, and/or collect the environmental information 20, which is information about factors extrinsic to the subscriber's behavior, by storing the collected information in a database (DB) built in the apparatus 300, or by communicating with an external server or a service system. Hereinafter, configurations and functions of components included in the service system of FIG. 1 will be described in detail.

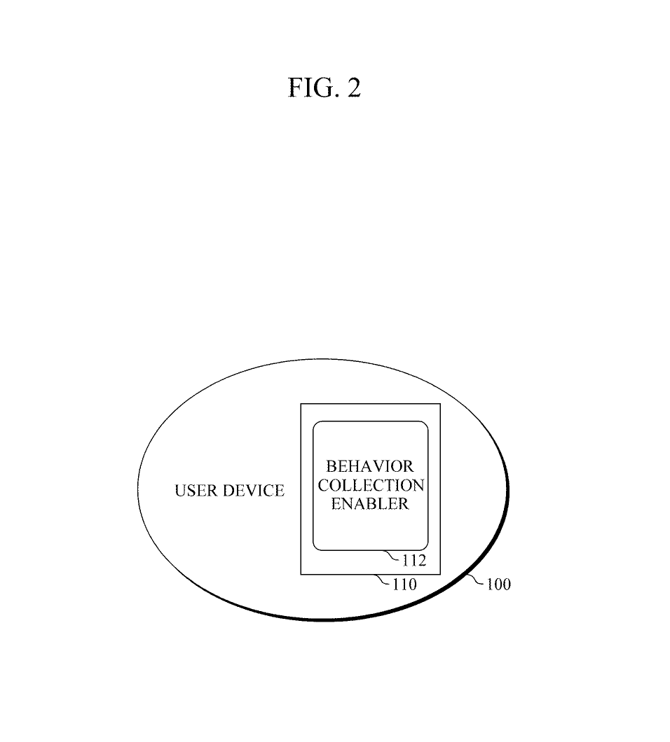

FIG. 2 is a diagram schematically illustrating the user device in the service system of FIG. 1. The user device 100, which is in a side of a subscriber that uses the Internet service 10, receives an input from the subscriber and outputs a response to the subscriber. Further, the user device 100 may retain user-specific information and its own device-specific information.

Referring to FIG. 2, the user device 100 includes a device agent 110 that includes a behavior collection enabler 112. As described above, the user device 100 may use at least one Internet service 10 through the network offered by the network provider 200 (refer to FIG. 1). When using the Internet service 10, the user device 100, more specifically, the device agent 110, transmits and receives packets, and these transmitted and received packets are analyzed in real-time so that the real-time-subscriber-behavior-information can be collected. In this example, the network provider 200 may collect the real-time-subscriber-behavior-information through the real-time analysis of packets and transmit the collected information to the big-data information provision apparatus 300, and/or the big-data information provision apparatus 300 may directly analyze the packets in real-time and collect the real-time-subscriber-behavior-information.

In this example, the real-time-subscriber-behavior-information may include the following information, which is only exemplary.
Information about accessed website and/or accessed webpage of the website
Information about service frequently used by user
Information about application frequently used by user

The device agent 10 may be installed in the user device 100 to collect the real-time-subscriber-behavior-information. The device agent 110, which is an application and/or a function provided by the network provider 200 and/or the big-data information provision apparatus 300, may be implemented as hardware or software. The device agent 110 may enable the network provider 200 and/or the big-data information provision apparatus 300 to perform functions required to collect the real-time-subscriber-behavior-information, for example, functions to collect all transmitted and received packets or, desirably, some packets that are related to the real-time-subscriber-behavior-information, and, if necessary, analyze the collected packets.

For collection of the real-time-subscriber-behavior-information based on the transmitted and received packets, the device agent 110 may include a behavior collection enabler 112. The behavior collection enabler 112 may be a function within the device agent 110 installed to collect the real-time-subscriber-behavior-information. For example, the behavior collection enabler 112 may provide an ON/OFF toggle function to permit or prohibit the collection of the real-time-subscriber-behavior-information (or transmitted and received packets, etc.). If the behavior collection enabler 112 is in ON state, information about the current behaviors of the subscriber, including information about the applications used by the user device 100, as well as information related to the services used by the user device 100 through the network is allowed to be collected by the network provider 200 and/or the big-data information provision apparatus 300. On the contrary, if the behavior collection enabler 112 is in OFF state, it is not permitted to collect all information about the subscriber's current actions done with the user device 100. The current state of the behavior collection enabler 112 (for example, ON or OFF state) may be arbitrarily determined by a user, and the determined state may be remained temporarily or permanently.

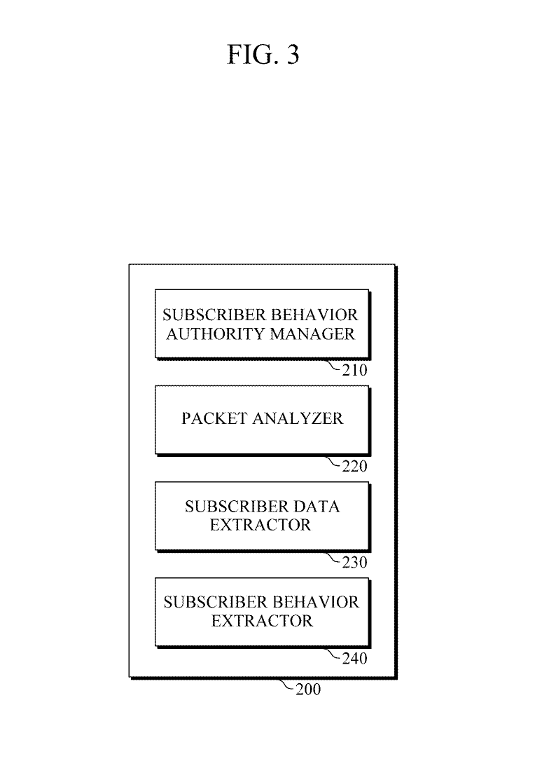

FIG. 3 is a diagram schematically illustrating the network provider of the service system of FIG. 1. The network provider 200 may be an ISP that offers a means for accessing the Internet. In one example, the network provider 200 may collect the real-time-subscriber-behavior-information by analyzing packets transmitted and received by the user device 100 through the Internet, and forward the collected information to the big-data information provision apparatus 300. In another example, the network provider 200 may only provide the basic functions as the Internet service provider, and the big-data information providing apparatus 300 may collect the real-time-subscriber-behavior-information. Herein, the description will be provided more focusing on the former example, that is, the collection of the real-time-subscriber-behavior-information by the network provider 200; however, the aspects of the disclosure may be equally applied to the latter example, i.e., the collection of the real-time-subscriber-behavior-information by the big-data information provision apparatus 300.

In FIG. 3, the configuration of the network provider 200 to collect the real-time-subscriber-behavior-information is schematically illustrated. Referring to FIG. 3, the network provider 200 includes a subscriber behavior authority manager 210, a packet analyzer 220, a subscriber data extractor 230, and a subscriber behavior extractor 240. When the behavior collection enabler 112 included in the device agent 110 is in ON state (refer to FIG. 2), the network provider 200 may analyze packets transmitted and received by the user device 100 and extract the subscriber behavior information. In addition, under the permission of the subscriber, the network provider 200 may install the device agent 110 in the user device 100 so as to collect the behavior information.

The subscriber behavior authority manager 210 determines whether the network provider 200 is authorized to analyze the subscriber's behaviors, and only when the network provider 200 is determined as authorized, it controls the network provider 200 to analyze. To this end, the subscriber behavior authority manager 210 may check whether the behavior collection enabler 112 is in ON state or OFF state. If the behavior collection enabler 112 is in ON state, the subscriber behavior authority manager 210 may request or direct the packet analyzer 220 to analyze the transmitted and received packets. If it is determined that the behavior collection enabler 112 is in OFF state, the subscriber behavior authority manager 210 may request or direct the packet analyzer 220 to stop analyzing the packets. In addition, the subscriber behavior authority manager 210 may record and store the ON/OFF time of the behavior collection enabler 112 and the changes of the relevant settings by a user.

In response to a request from the subscriber behavior authority manager 210, the packet analyzer 220 monitors and analyzes data packets generated by the user device 100. In this case, the data packets generated by the user device 100 refer to data packets that the user device 100 transmits and receives through the network provider 200 while using the Internet service 100. The packet analyzer 220 may analyze the transmitted and received packets to select packets, from among the all packets, that include data related to the real-time-subscriber-behavior-information. However, aspects of the present disclosure are not limited to any specific algorithm or analysis method for the packet analyzer 220 to analyze the packets.

The subscriber data extractor 230 may extract subscriber data from the data packets analyzed or selected by the packet analyzer 220. The subscriber data extractor 230 may extract, from the selected packets, all subscriber data or specific some subscriber data (i.e., information related to the real-time-subscriber-behavior-information) that is required by the big-data information provision apparatus 300.

The subscriber behavior extractor 240 extracts a subscriber behavior using the subscriber data extracted by the subscriber data extractor 230. More specifically, the subscriber behavior extractor 240 may generate information that indicates a specific subscriber behavior, i.e., the real-time-subscriber-behavior-information, from the extracted subscriber data, which is extracted from packets that are associated with the specific subscriber behavior. The real-time-subscriber-behavior-information is information related to the subscriber's behavior that is caused when the subscriber uses the Internet service 10 (refer to FIG. 1), and this information is not limited to any specific type. For example, the real-time-subscriber-behavior-information may include all or some of the following: information about a web page accessed by the subscriber, service usage information about a service used by the subscriber in the accessed web page, and application usage information about an application used by the subscriber.

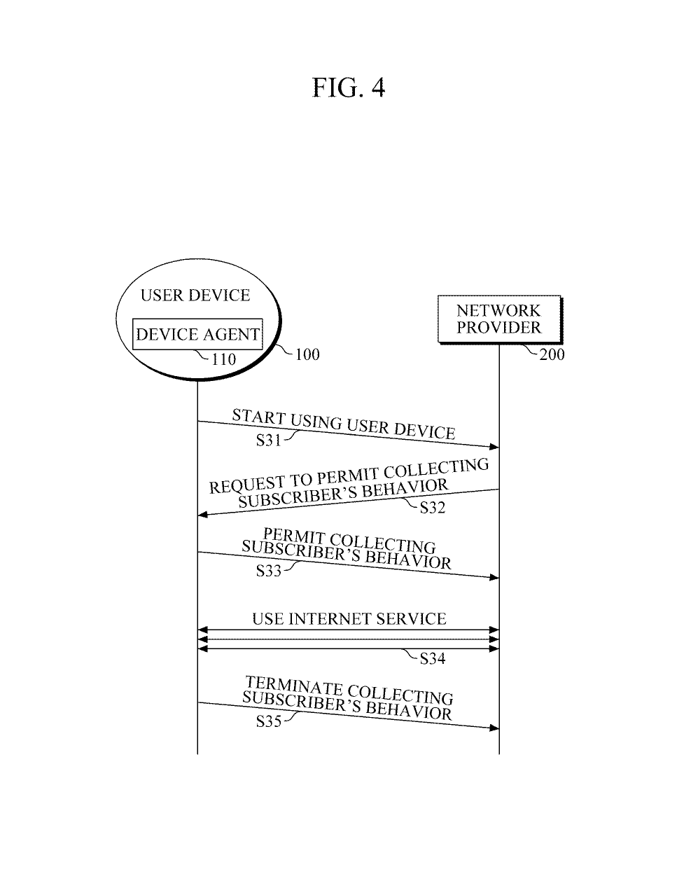

As such, in order for the network provider 200 to generate the real-time-subscriber-behavior-information from the transmitted and received packets, it may be a prerequisite to seek permission from the subscriber through the user device 100 to extract such behavior information. More specifically, the network provider 200 may need to communicate with the user device 100 according to a predetermined communication protocol and obtain permission from the subscriber to collect and analyze transmitted and received packets so as to generate the real-time-subscriber-behavior-information. FIG. 4 illustrates a flowchart of an example of such procedures to obtain subscriber's permission to collect the real-time-subscriber-behavior-information.

Referring to FIG. 4, once a subscriber begins to use the user device 100 by necessity, the device agent 110 transmits information related to the start of using the device to the network provider 200 in S31. For example, the device agent 110 may determine whether the behavior collection enabler 112 (refer to FIG. 2) is in ON state or OFF state, upon detecting the start of the user device 100, and deliver the determination result to the network provider 200 in S31. In one example, only when determining that the behavior collection enabler 112 is in OFF state, the device agent 110 may notify it to the network provider 200. This is because when the behavior collection enabler 112 is in ON state, it implies that the subscriber's permission to analyze the transmitted and received packets is already given to the network subscriber 200.

In response to receiving the information about the start of using the user device or information indicating that the behavior collection enabler 112 is in OFF state from the device agent 110, the network provider 200 transmits a subscriber behavior collection permission request signal to the user device 100 in S32. The subscriber behavior collection permission request signal is to ask for permission of packet analysis for collecting real-time-subscriber-behavior-information. Thus, operation S32 (and subsequent operation S33) can be performed in response to the message received in S31, but only when the message indicates that the behavior collection enabler 112 of the user device 100 is OFF state.

In S33, the user device 100 transmits a subscriber behavior collection permission signal to the network provider 200 in response to the request from the network provider 200. The subscriber behavior collection permission signal may be generated and transmitted by the device agent 110 in response to the user's input or according to a predetermined rule (for example, whether the user's pre-set condition (time or type of network provider) is met). The subscriber behavior collection permission signal may further include information about a predetermined condition (allowable time or allowable behavior) for permission.

In S34, the user device 100 uses one or more Internet services through the network provider 200. That is, the subscriber uses the Internet services using the user device 100. When using the Internet services, the user device transmits and receives packets through the Internet. In S35, the user device 100 may terminate the permission of collection of subscriber behavior information anytime. In this case, the device agent 110 of the user device 100 may turn off the behavior collection enabler in response to a subscriber's input or according to a preset condition that is satisfied.

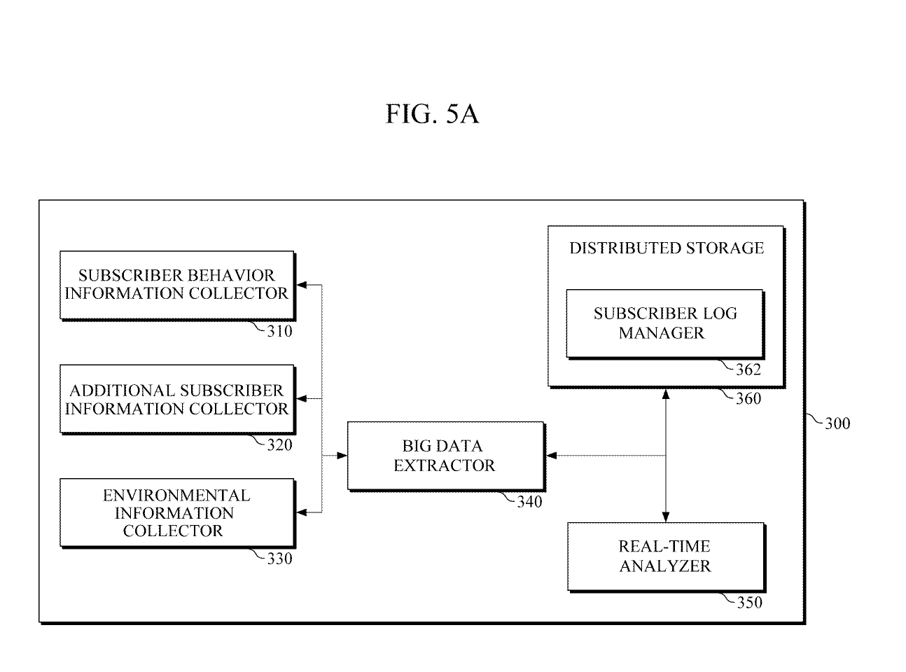

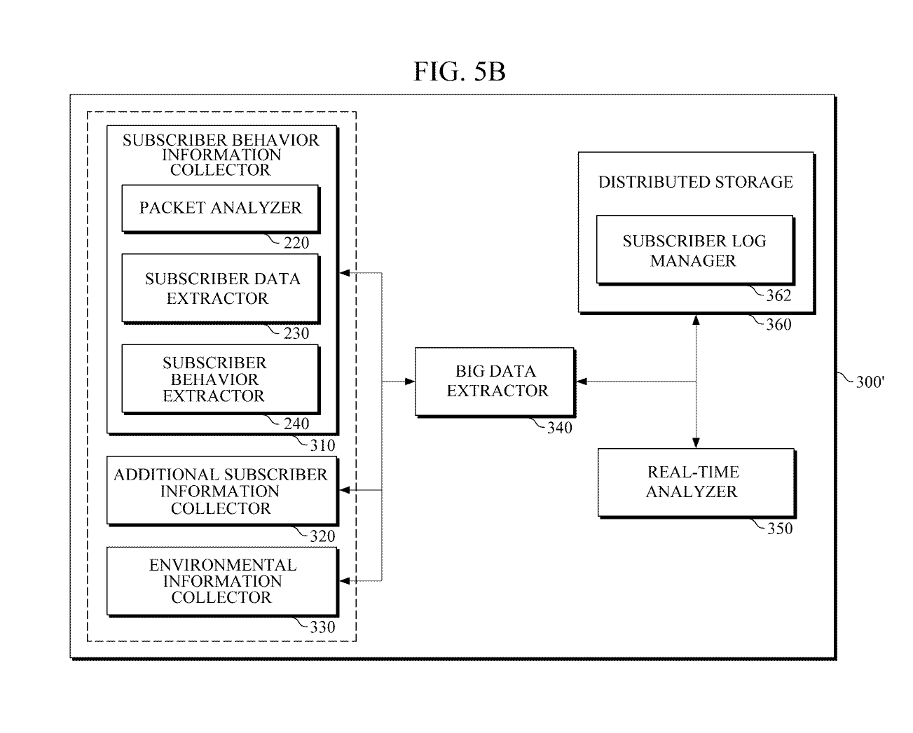

FIG. 5A is a diagram schematically illustrating an example of the big-data information provision apparatus in the service system of FIG. 1. FIG. 5B is a diagram schematically illustrating another example of the big-data information provision apparatus in the service system of FIG. 1. In comparison between FIG. 5A and FIG. 5B, the big-data information provision apparatus 300′ of FIG. 5B differs from the big-data information provision apparatus 300 of FIG. 5A in that a subscriber behavior information collector 310 includes a functional unit to extract a subscriber behavior. The functional unit to extract a subscriber behavior may include the packet analyzer 220, the subscriber data extractor 230, and the subscriber behavior extractor 240, which are all included in the network provider 200 as described with reference to FIG. 3. In other words, a manager of the big-data information provision apparatus 300′ of FIG. 5B may execute some functions of the network provider 200 to extract the subscriber behavior, and in this case, the network provider 200 may only be able to execute the same functions as those of the existing ISP, as well as the function of the subscriber behavior authority manager 210.

The big-data information provision apparatus 300 and 300′ may collet subscriber-related information and environmental information, as well as the real-time-subscriber-behavior-information. The big-data information provision apparatus 300 and 300′ manages all log information related to the subscriber. The big-data information provision apparatus 300 or 300′ may store all collected information in a predetermined repository. In addition, the big-data information provision apparatus 300 or 300′ may extract real-time subscriber big data using the stored information and generate real-time characteristic information related to the subscriber by analyzing the cumulatively stored big data. The real-time characteristic information generated by the big-data information provision apparatus 300 and 300′ may be forwarded to the big data user 400 (refer to FIG. 1). The big data user 400 may directly provide a subscriber-customized Internet service by utilizing the real-time characteristic information related to the specific subscriber, or may allow other Internet providers to utilize the information.

Hereinafter, the big-data information provision apparatus 300 and 300′ will be described in detail with reference to FIGS. 5A and 5B. However, detailed explanations of functions of the components of the subscriber behavior information collector 310 in FIG. 5B, that is, the packet analyzer 220, the subscriber data extractor 230, and the subscriber behavior extractor 240, will not be repeated since the same are fully described with reference to FIG. 3. Referring to FIGS. 5A and 5B, the big-data information provision apparatus 300 and 300′ includes the subscriber behavior information collector 310, an additional subscriber information collector 320, an environmental information collector 330, a big data extractor 340, and a real-time analyzer 350. The big-data information provision apparatus 300 and 300′ may further include a distributed storage 360.

The subscriber behavior information collector 310 may collect real-time-subscriber-behavior-information that is obtained based on the packets that the user device transmits and receives in real-time when using an Internet service. For example, the subscriber behavior information collector 310 may collect the real-time-subscriber-behavior-information obtained by analyzing in real-time the transmitted and received packets. In this case, the real-time-subscriber-behavior-information may be extracted by the network provider 200 of FIG. 3, more specifically, the subscriber behavior extractor 240, and/or by the subscriber behavior extractor 240 of the big-data information provision apparatus 300′ of FIG. 5B. In the former case, there is no need of a single network provider 200, and the subscriber behavior information collector 310 may collect the real-time-subscriber-behavior-information extracted by multiple network providers 200.

The additional subscriber information collector 320 may collect subscriber-related information including personal information. The subscriber-related information as additional subscriber information refers to information that excludes the subscriber behavior information, and generally may be provided in structured or semi-structured data format. For example, the additional subscriber information may include the location information of the subscriber as well as the age, gender, preference of the subscriber.

The environmental information collector 330 may collect the environmental information 20 (refer to FIG. 1) which is information about factors extrinsic to the subscriber's behavior. The environmental information does not refer to all environmental information, but only refers to information required to analyze the subscriber's behavior. The environmental information may be in semi-structured or non-structured data format. For example, the environmental information may include information about factors extrinsic to the subscriber's behavior, such as, weather, season, national events, holiday information, and the like. The sources of the environmental information 20 may not be necessarily specifically determined, and addition, alteration and deletion of the information are possible.

The big data extractor 340 may extract real-time subscriber big data using the real-time-subscriber-behavior-information collected by the subscriber behavior information collector 310, the subscriber-related information collected by the additional subscriber information collector 320, and the environmental information collected by the environmental information collector 330. The extracted real-time subscriber big data, which is extracted by a predetermined algorithm utilizing all or some of the collected information, refers to a group of data related to the subscriber at present. The subscriber big data is not limited in type or format, and the scope or content thereof may be determined according to policies of an operator of the big-data information provision apparatus 300. In addition, the extracted real-time subscriber big data is not limited to any specific format, and the big data may be structured, semi-structured, or non-structured data.

The data extracted by the big data extractor 340 may be all stored in the big-data information provision apparatus 300, more specifically in the distributed storage 360, or only some selected data may be stored in the distributed storage 360. To this end, the big data extractor 340 may operate according to one of the following three models or two or three of the other models may alternate independently.

(Model 1) A method of not storing extracted big data. Big data is extracted from various data sources, the real-time analyzer 350 is allowed to use the extracted big data, but the extracted data is deleted without being stored. Thus, the big data extractor 340 that operates according to this model does not need to forward the generated real-time subscriber big data to the distributed storage 360.

(Model 2) A method of storing some of extracted big data. In this model, big data is extracted from various data sources and the real-time analyzer 350 is allowed to use the big data; but only some of the extracted big data is stored and the remaining data is deleted. Hence, the big data extractor 340 that operates according to Model 2 forwards some of the generated real-time subscriber big data to the distributed storage 360.

(Model 3) A method of storing all big data. In this model, big data is extracted from various data sources, the real-time analyzer 350 is allowed to use the big data, and all extracted data is stored. Thus, the big data extractor 340 that operates according to Model 3 forwards all generated real-time subscriber big data to the distributed storage 360.

The real-time analyzer 350 may generate subscriber's real-time characteristic information related to the subscriber by analyzing accumulated real-time subscriber big data which is extracted by the big data extractor 340. The real-time extractor 350 generates the subscriber's real-time characteristic information based on both the real-time subscriber big data that is obtained for the specific subscriber at present and the real-time subscriber big data that has been already obtained for the same subscriber. In the process of generating the subscriber's real-time characteristic information, the way how the real-time analyzer 350 utilizes the previously obtained data and currently obtained data may vary according to policies of the operator of the big-data information provision apparatus 300.

The distributed storage 360 may store the subscriber's real-time characteristic is information generated by the real-time analyzer 350 in a distributed environment. Thus, the data stored in the distributed storage 360 corresponds to cumulative data that is to be analyzed to be used by the real-time analyzer 350 to generate the current subscriber's real-time characteristic information. In addition, the current real-time characteristic information generated by the real-time analyzer 350 may also be stored in the distributed storage 360. To this end, the real-time analyzer 350 may forward the generated subscriber's real-time characteristic information to the distributed storage 360.

The distributed storage 360 may store a subscriber's previous real-time characteristic information forwarded from the real-time analyzer 350, that is, cumulative big data associated with the specific subscriber. The distributed storage 360 may further include a subscriber log manager 370 to manage information on a subscriber's past behavior. The information on a subscriber's past behavior may be, for example, information about TV dramas that the subscriber is recently interested in, information about the subscriber's past preference to a specific product, or the like. In one example, the information on a subscriber's past behavior may be stored in the subscriber log manager 370 of the distributed storage 360. The real-time analyzer 350 may also use the information stored in the subscriber log manager 370 when generating the subscriber's real-time characteristic information.

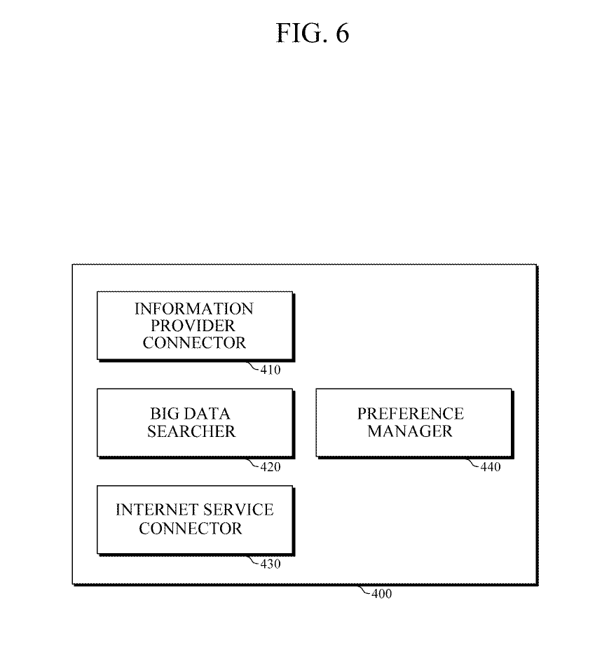

FIG. 6 is diagram schematically illustrating a big data user 400 to use the subscriber's real-time characteristic information generated by the big-data information provision apparatus 300 (refer to FIG. 1). Referring to FIG. 6, the big data user 400 includes an information provider connector 410, a big data searcher 420, an Internet service connector 430, and a subscriber preference manager 440. The big data user 400 receives the subscriber's real-time characteristic information from the big-data information provision apparatus 300 and uses the received information in a variety of ways. In this example, the big data user 400 is not limited to a specific method to utilize the subscriber's real-time characteristic information. In FIG. 6, the subscriber's real-time characteristic information may be utilized for the Internet service 10 (refer to FIG. 1).

The information provider connector 410 may connect with another big-data information provision apparatus that provides subscriber's real-time characteristic information. Accordingly, the big data user is able to use the big-data information provision apparatus like a local system. In other words, even when using only one big-data information provision apparatus 300, the big data user is allowed to obtain and use subscriber's real-time characteristic information provided by the other big-data information provision apparatus.

The big data searcher 420 may connect with the real-time analyzer 350 and the distributed storage 360 and search for big data using a predetermined big data query language. The big data query language is not limited to any specific type, and may include Hive, Impala, Dremel, Drill, Tajo, and the like.

The Internet service connector 430 may deliver, in real-time, the subscriber's preference information to at least one Internet service 10 (refer to FIG. 1) that is being provided to the subscriber, according to the subscriber's behavior. The Internet service connector 430 may provide the subscriber's real-time characteristic information, generated by the big-data information provision apparatus 300, to the Internet service 10 that intends to utilize it. The subscriber preference manager 440 may store and manage information regarding preferences that the subscribers may have during the collection of the subscriber's behaviors, so as to enable the Internet service 10 to use the information.

The above examples may be implemented for various purposes as described below. Detailed examples are described herein with reference to FIG. 1.

The network provider 200 obtains additional subscriber information and environmental information, as well as real-time-subscriber-behavior-information, through the user device 100. Then, the big data extractor extracts the real-time subscriber big data from the obtained information, and the real-time analyzer analyzes the current real-time subscriber big data and the previously accumulated real-time subscriber big data, so as to generate subscriber's real-time characteristic information. The generated subscriber's real-time characteristic information may be forwarded to the big data user 400. The big data user 400 may provide a subscriber-customized Internet service (for example, advertisement in a form that may interest the subscriber at present) by utilizing the subscriber's real-time characteristic information.

For example, the subscriber's real-time characteristic information generated by the big-data information provision apparatus 300 may be provided to an advertising carrier, so that the advertising carrier can offer a personalized advertisement to each individual subscriber. In one example, if a subscriber looks for movie-related information, the advertising carrier may provide information about theaters that show the movie searched by the subscriber based on the location information of the subscriber, as well as an advertisement of movies that the subscriber is interested in based on the subscriber's real-time characteristic information generated by the big-data information provision apparatus 300. In addition, the advertising carrier may also provide the subscriber with information about online movie content service providers.

In another example, the above examples may be applicable to a user of mobile cloud computing. In the mobile cloud computing environment, mobile device resources are re-used, which include content stored by a mobile device resource provider, functions provided by the mobile device resource provider, and applications installed in the mobile device resource provider. In this case, it may be possible to recommend or provide mobile device resources to the user of the mobile cloud computing at anytime, anywhere, based on the user's action. In one example, if the user of the mobile cloud computing takes a picture using a smart device, the network provider 200 or the big-data information provision apparatus 300 may collect the user's behavior and extract the real-time user big data using user-related information and environmental information. Then, the network provider 200 or the big-data information provision apparatus 300 may generate real-time-user-characteristic information and provide it to the big data user 400. In this example, the big data user 400 may recommend a photo editing tool (or a photo editing application) or a photo editing application from a mobile cloud environment, based on the real-time-user-characteristic information.

With an increase in use of the Internet, the proliferation of smartphones, and the development of cloud computing and big data technologies, user behavior information of an Internet service user can be analyzed in real-time. According to the above examples of the system and apparatus, it is possible for Internet service providers to offer various services such as s user-personalized content and advertisements, based on the analysis of the user behavior information. The analysis of user behavior has an increasing potential value, and is being expected as a new growth engine for the future IT industry. Further, performance of mobile devices have been improved, with a trend toward high-speed, high-capacity mobile devices, and methods of utilization of such high performance, advanced mobile devices may be diversified as use of these devices increases over time.

Conventionally, a user-customized service is able to be provided within only an Internet service provider. On the contrary, according to the above disclosure, it is possible to enable Internet service providers to analyze user characteristics and share the analysis result therebetween, and to provide a user-customized service based on the analysis result of the user is characteristics. Additionally, the apparatus and method according to the above disclosure may be applicable to mobile-based business and advertising, previously impossible based on user behavior. Further, the above disclosure may be applicable to user-customized content provision and advertising, which may contribute to development of relevant industries.

According to the above disclosure, it is possible to provide a user-customized Internet service by utilizing not only real-time behavior information of an Internet service user but also environmental information, additional user information, and previously stored user big data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing big data information based on a subscriber's real-time behavior, comprising:
a subscriber behavior information collector configured to collect real-time-subscriber-behavior-information obtained based on packets that a user device transmits and receives in real-time when using an Internet service;
an additional subscriber information collector configured to collect subscriber-related information including personal information;
an environmental information collector configured to collect environmental information that is information about factors extrinsic to subscriber's behavior;
a big data extractor configured to extract real-time subscriber big data using the collected real-time-subscriber-behavior-information, subscriber-related information, and environmental information; and
a real-time analyzer configured to generate subscriber's real-time characteristic information associated with the subscriber by analyzing cumulative big data that is generated by accumulating the real-time subscriber big data extracted by the big data extractor.

2. The apparatus of claim 1, further comprising:
a distributed storage configured to store the cumulative big data in a distributed environment,
wherein the real-time analyzer is configured to analyze the cumulative big data stored in the distributed storage.

3. The apparatus of claim 2, wherein the distributed storage is configured to comprise a subscriber log manager to manage information on a past behavior of the subscriber.

4. The apparatus of claim 2, wherein:
the distributed storage is configured to further store the subscriber's real-time characteristic information generated by the real-time analyzer, and
the real-time analyzer is configured to generate subscriber's real-time characteristic information by additionally using subscriber's real-time characteristic information previously stored in the distributed storage.

5. The apparatus of claim 1, wherein the real-time-subscriber-behavior-information comprises at least one of following information: information about a web page accessed by the subscriber, service usage information about a service used by the subscriber in an accessed web page, and application usage information about an application used by the subscriber.

6. The apparatus of claim 1, wherein either or both of a network provider and a manager of the apparatus executes analysis of the packets transmitted and received to obtain the real-time- subscriber-behavior-information.

7. The apparatus of claim 6, wherein the subscriber behavior information collector is configured to comprise: a packet analyzer configured to analyze packets in real-time that are transmitted and received by the user device; a subscriber data extractor configured to extract subscriber data using analysis result of the packet analyzer; and a subscriber behavior extractor configured to extract the real-time-subscriber-behavior-information from the subscriber data extracted from the subscriber data extractor.

8. The apparatus of claim 7, wherein the user device is configured to comprise a behavior collection enabler to enable the subscriber to decide to permit or not to permit real-time analysis of the packets that the subscriber device transmits and receives, and the subscriber behavior information collector is configured to further comprise a subscriber behavior authority manager to manage information about whether or not it is permitted to collect the real-time behavior information from the user device, based on ON/OFF state of the behavior collection enabler.

9. The apparatus of claim 1, wherein in response to a request from a big data system user for big data information associated with a specific subscriber, the real-time analyzer generates real-time characteristic information of the specific subscriber and forwards the information to the big data system user.

10. The apparatus of claim 9, wherein the big data system user comprises a subscriber preference manager to manage preference of the subscriber using the forwarded real-time characteristic information of the subscriber.

11. A method of providing big data information based on a real-time behavior of a subscriber using an Internet service, the method comprising:
collecting real-time-subscriber-behavior-information based on packets that a user device transmits and receives in real-time when using an Internet service;
collecting subscriber-related information including personal information;
collecting environmental information that is information about factors extrinsic to the subscriber's behavior;
extracting real-time subscriber big data using the collected real-time-subscriber-behavior-information, subscriber-related information, and environmental information; and
generating subscriber's real-time characteristic information associated with the subscriber by analyzing cumulative big data that is generated by accumulating the extracted real-time subscriber big data.
